(19) United States
(12) Patent Application Publication
(10) Pub. No.: US 2016/0039040 A1
(43) Pub. Date: Feb. 11, 2016

(54) METHOD OF FUSING EDGE MEMBERS TO METALLIC COMPONENTS

(71) Applicant: Caterpillar Inc., Peoria, IL (US)

(72) Inventor: JEFF A. JENSEN, DUNLAP, IL (US)

(73) Assignee: Caterpillar Inc., Peoria, IL (US)

(21) Appl. No.: 14/886,127

(22) Filed: Oct. 19, 2015

(51) Int. Cl. B23K 13/02

(52) U.S. Cl. CPC B23K 13/02

(57) ABSTRACT

A method of fusing an edge member to a peripheral portion of the metallic component is disclosed. The method initiates with providing an edge forming apparatus, which includes a manipulator, a heating unit, and at least one set of rollers. The manipulator is capable of receiving the edge member and the metallic component. Thereafter, edge member and the metallic component are positioned on the manipulator. After positioning, the heating unit heats a first portion of the edge member and a first section of the peripheral portion. Thereafter, the manipulator is manipulated to facilitate an engagement between the first portion and the first section, by passing the first portion and the first section through the set of rollers. Afterwards, the first portion of the edge member is fused with the first section of the peripheral portion of the metallic component.

### TECHNICAL FIELD

The present disclosure relates generally to reinforcement of peripheral edges of metallic components. More specifically, the present disclosure relates to a method of fusing thickened edge members to metallic components with use of an edge forming apparatus.

### BACKGROUND

Various mechanical components, such as booms, linkages, work implements, and the like, of construction machines are generally manufactured by welding a number of planar metallic components with each other. For example, a boom of an excavator is manufactured by welding together generally four differently shaped metallic components to form an integrated boom structure. During a welding process, stress concentrations at a weld joint between two metallic components may be relatively high Such a condition may cause a failure of the weld joint. In order to avoid such failures, an edge of each metallic component that forms a part of the weld joint, may be kept relatively thicker than an adjacent portion of the metallic component.

Conventional methods of thickening the edge of the metallic component include substantially linearly passing the edge of the metallic component against a number of rollers, with an application of force. However, this method of thickening is irregular, and reduces an overall dimension of the metallic component and affects general material characteristics. Moreover, such a process may require several pre-calculations to meet dimensional demands of a final product and may require significant energy inputs or multiple time-consuming forming passes.

Alternatively, a relatively thicker plate may be used as the metallic component, to avoid structural failures of the metallic component. However, the thicker plate increases the bulk and complexity in handling of the metallic component. Commensurately, this leads to an increased investment of capital and time in manufacturing such components and an effort spent in such developments is generally unduly laborious.

U.S. Pat. No. 5,024,074 discloses a method of selectively forming a thickened edge on a plate of formable metallic material. The method includes selectively forming a non-linear edge of the plate into a prescribed thickness and shape by introducing the plate against at least a set of rollers. However, this methodology also causes a reduction in an overall dimension of the plate, which may again require several calculations to meet dimensional demands of the mechanical component and may require significant energy inputs or multiple time-consuming forming passes.

### SUMMARY OF THE INVENTION

Various aspects of the present disclosure are directed towards a method of fusing an edge member to a peripheral portion of a metallic component. The method initiates with providing an edge forming apparatus with a manipulator capable of receiving the edge member and the metallic component. The edge forming apparatus includes a heating unit and at least one set of rollers. The edge member and the metallic component are then positioned on the manipulator. Thereafter, a first portion of the edge member and a first section of the peripheral portion are heated with use of the heating unit of the edge forming apparatus. After heating, the manipulator is manipulated to facilitate an engagement between the first portion of the edge member and the first section of the peripheral portion by passing the first portion and the first section through the at least one set of rollers. Then, the first portion of the edge member is fused with the first section of the peripheral portion of the metallic component.

### BRIEF DESCRIPTION OF THE DRAWINGS

FIG. 1 is a perspective view of a mechanical component of a construction machine;

FIG. 2 is a diagrammatic view of an edge forming apparatus and a method associated therewith, used to fuse an edge member to a peripheral portion of the metallic component of FIG. 1;

FIG. 3 is a diagrammatic view of an alternate embodiment of the edge forming apparatus and an associated method, used to fuse the edge member to the peripheral portion of the metallic component of FIG. 1; and

FIG. 4 is a flow chart of method of fusing the edge member to the peripheral portion of the metallic component.

### DETAILED DESCRIPTION

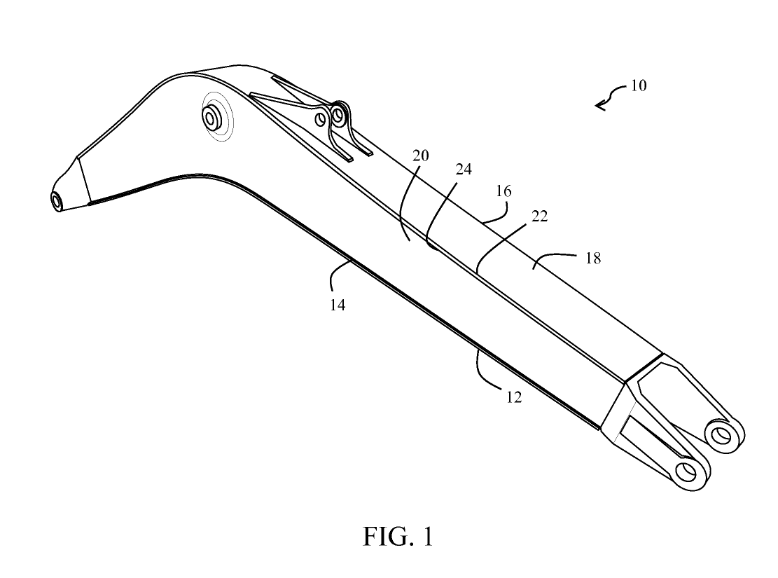

Referring to FIG. 1, there is shown a mechanical component 10 of a construction machine (not shown). The mechanical component 10 is a boom 10 of an excavator (not shown). For ease in reference, the mechanical component 10 will be referred to as the boom 10, interchangeably hereinafter. Although, concepts of the present disclosure are described with reference to the boom 10 as the mechanical component 10, an application to various other mechanical components, may also be contemplated. Examples of the mechanical components 10 may include, but is not limited to, a stick of the excavator, a cab structure of the excavator, a frame of the excavator. An extension to similar components and structures, such as but not limited to, machines, truck bodies, bridges, and buildings, may also be contemplated.

The boom 10 generally includes a base plate 12, a first side plate 14, a second side plate 16, and a top plate 18. The base plate 12, the first side plate 14, the second side plate 16, and the top plate 18 are welded together in a cuboidal manner to form a closed structure of the boom 10 of the excavator (not shown). For ease in understanding, concepts of the present disclosure will be described as applied to the first side plate 14 of the boom 10, hereinafter. Applicability of the concepts of the present disclosure to various other components of the boom 10 may also be contemplated, such as but not limited to, the base plate 12, the second side plate 16, and the top plate 18.

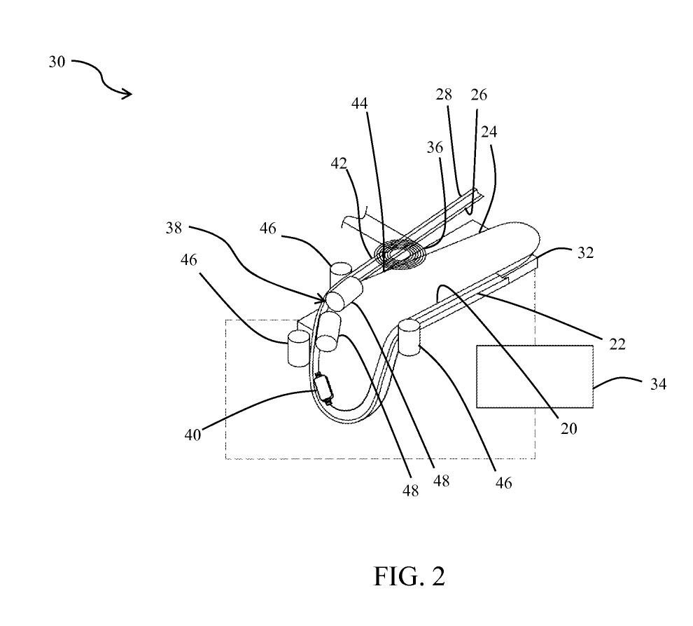

The first side plate 14 of the boom 10 is a boomerang shaped steel fabrication that is made of a metallic component 20 and an edge member 22. In the current embodiment, the first side plate 14 is manufactured by fusing the edge member 22 to a peripheral portion 24 of the metallic component 20. A method of fusing the edge member 22 to the peripheral portion 24 (FIG. 2) of the metallic component 20 will be later described in details.

Referring to FIGS. 1 and 2, the metallic component 20 is generally a boomerang shaped steel plate that defines the peripheral portion 24. Various methods of manufacturing the metallic component 20 may be contemplated, such as, casting, deep drawing, expanding, and/or laser cutting. Although, the metallic component 20 is described to include a profile similar to that of the boomerang, various other profiles of the metallic component 20, may also be contemplated. Moreover, although, the present disclosure discusses the metallic component 20 as made of steel material, it may be contemplated that the metallic component 20 may be made of various other material, such as but not limited to, aluminum, cast iron, and/or alloys.

The edge member 22 is an elongated steel component preformed to a specific cross-section. In an embodiment, the edge member 22 includes a component attachment portion 26 (FIG. 2) and a thickened portion 28 (FIG. 2). The component attachment portion 26 (FIG. 2) is generally equal in thickness relative to the metallic component 20. The thickened portion 28 (FIG. 2) is relatively thicker than the component attachment portion 26 (FIG. 2) and is in turn relatively thicker than the metallic component 20. The component attachment portion 26 (FIG. 2) of the edge member 22 is fused to the peripheral portion 24 of the metallic component 20 with use of an edge forming apparatus 30 (FIG. 2). Although, the present disclosure discusses the edge member 22 as made of steel material, it may be contemplated that the edge member 22 may be made of various other material, such as but not limited to, aluminum, cast iron, and/or alloys.

Referring to FIG. 2, there is shown the edge forming apparatus 30 used to fuse the edge member 22 to the peripheral portion 24 of the metallic component 20. Although, the present disclosure discloses the edge forming apparatus 30 to fuse the edge member 22 of steel material and the metallic component 20 of steel material, the edge forming apparatus 30 may also be used to fuse the metallic component 20 and the edge member 22, made of various other materials. In an embodiment, the edge forming apparatus 30 follows a solid-state fusion process, to fuse the edge member 22 to the metallic component 20. The edge forming apparatus 30 includes a manipulator 32, a control unit 34, a heating unit 36, at least one set of rollers 38, and a scarfing tool 40.

The manipulator 32 is a flat table capable of being rotated and panned. Such a manipulation is performed substantially in a horizontal plane, although it is contemplated that a manipulation may occur in three dimensions. The manipulator 32 is manipulated by the control unit 34, in a manner required to mate the component attachment portion 26 of the edge member 22 with the peripheral portion 24 of the metallic component 20. This manipulation occurs alongside the set of rollers 38 that facilitate sandwiching of the edge member 22 relative to the peripheral portion 24 of the metallic component 20. Moreover, the manipulation occurs according to a profile of the peripheral portion 24 of the metallic component 20. Although, the manipulator 32 is described as a flat table capable of being manipulated by the control unit 34, various other type of the manipulator 32, may also be contemplated. For example, a number of robotic arms (not shown) may be employed as the manipulator 32, to manipulate the metallic component 20 and the edge member 22.

The control unit 34 facilitates controlled manipulation of the manipulator 32, corresponding to the profile of the peripheral portion 24 of the metallic component 20. The control unit 34 includes an actuator (not shown) and a processor (not shown). The actuator (not shown) is mechanically coupled to the manipulator 32. Generally, the profile of the peripheral portion 24 is predefined in the processor (not shown) and the actuator (not shown) is adapted to manipulate the manipulator 32, corresponding to the profile defined in the processor (not shown) of the control unit 34.

The heating unit 36 is a spirally wound induction heating equipment installed proximal to a portion of the manipulator 32. More specifically, a robotic arm (not shown) supports the heating unit 36, to install the heating unit 36 proximal to the manipulator 32. The heating unit 36 may include an electrically energized heating element that inductively imparts heat to a proximal component, when energized. The heating unit 36 is adapted to facilitate pre-heating of the edge member 22 and the metallic component 20, such that the edge member 22 is able to bend and conform to a profile of the metallic component 20. More specifically, the heating unit 36 imparts heat to a first portion 42 of the edge member 22 and a first section 44 of the peripheral portion 24 of the metallic component 20, when the metallic component 20 and the edge member 22 are positioned on the manipulator 32. The first section 44 and the first portion 42 correspond to those portions of the edge member 22 and the metallic component 20 that are planned for an impending engagement. Although, the present disclosure contemplates spirally wound induction heating equipment as the heating unit 36, various other types of heating unit 36 may also be contemplated. Examples of the heating unit 36 may include, but is not limited to, an electric resistive heating equipment, a heating furnace, a pass-through heating equipment, and a conductive heating equipment. Auxiliary modes of heating may be also be contemplated. For example, heat may be provided by a heat blower or by being fluidly connected to a pre-existing heat sink, or even by receiving heat generated from the operation of the manipulator 32, and the like. Therefore, heating provisions attributed to an enclosure, as shown, need to be seen as being purely exemplary in nature.

The set of rollers 38 are installed proximal to another portion of the manipulator 32, in accordance with a layout plan of the metallic component 20. More particularly, the set of rollers 38 are installed along a path of formation of joint between the edge member 22 and the metallic component 20. The set of rollers 38 are supported by robotic arms (not shown), to install the set of rollers 38 proximal to the manipulator 32. In the current embodiment, the set of rollers 38 generally include a first set of vertical rollers 46 and a second set of horizontal rollers 48.

The vertical rollers 46 are adapted to push the metallic component 20 and the edge member 22 towards each other and facilitate an abutted engagement between the first portion 42 of the edge member 22 and the first section 44 of the metallic component 20. More specifically, the vertical rollers 46 are three rollers, two of which push the edge member 22 against the metallic component 20 along a first direction, while one roller pushes the metallic component 20 against the edge member 22, in an opposite direction. Although, the present disclosure describes usage of three rollers as the vertical rollers 46, a varied number of the vertical rollers 46, may be contemplated.

The horizontal rollers 48 are two in number. The horizontal rollers 48 are positioned over and to generally complement and maintain the planar profile of the metallic component 20. In that way, the horizontal rollers 48 press against a plane of the manipulator 32 and ascertain that a surficial deformation and aberrations of a newly formed unison between the metallic component 20 and the edge member 22 is adequately prevented. Although, the present disclosure describes usage of two rollers as the horizontal rollers 48, a varied number of the horizontal rollers 48, may be contemplated.

The scarfing tool 40 is further installed along the path of formation of joint assumed between the metallic component 20 and the edge member 22, proximal to the manipulator 32. The scarfing tool 40 is supported by another robotic arms (not shown), to install the scarfing tool 40 proximal to the manipulator table 32. The scarfing tool 40 is adapted to remove weld burrs, and roughened portions, and jagged ends, of the joint resulting from combining the edge member 22 to the metallic component 20, after passage through the set of rollers 38. The scarfing tool 40 may be a generally thin-cut, generally hard, sharpened tool, having a conventional knife-like profile that enables smoothening of the interface formed between the edge member 22 and the metallic component 20. A general utility of the scarfing tool 40 lies in providing a seamless joint between the edge member 22 and the metallic component 20.

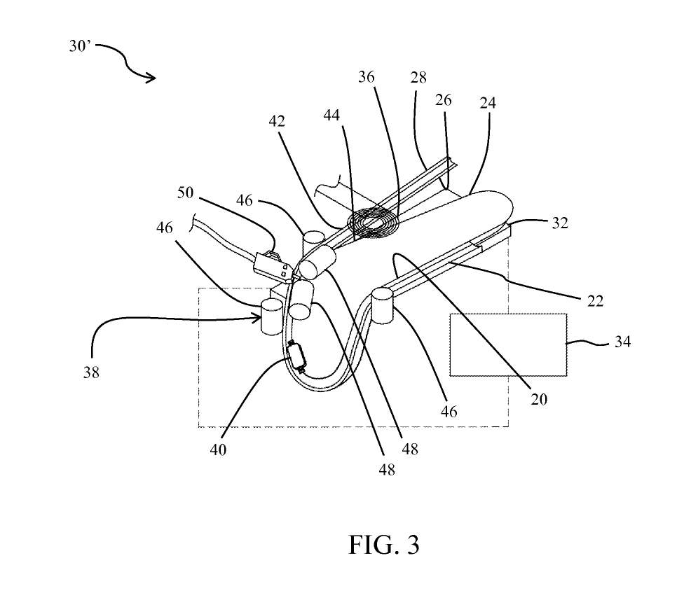

Referring to FIG. 3, there is shown an alternate embodiment of the edge forming apparatus 30′. In the alternate embodiment, the edge forming apparatus 30′ follows a liquid-state fusion process, to fuse the edge member 22 to the metallic component 20. The edge forming apparatus 30′ includes the manipulator 32, the heating unit 36, the at least one set of rollers 38, the scarfing tool 40, the control unit 34, and a welding torch 50. The heating unit 36 is adapted to heat the first portion 42 of the edge member 22 to a relatively lower temperature than the previous embodiment of the edge forming apparatus 30.

While details of the edge forming apparatus 30′ remains generically same, as discussed in FIG. 2, in the FIG. 3 embodiment, the welding torch 50 is installed between two of the horizontal rollers 48 of the set of rollers 38, where the edge member 22 engages with the metallic component 20. The welding torch 50 is adapted to facilitate a weld joint between the first portion 42 of the metallic component 20 and the first section 44 of the edge member 22. The welding torch 50 may be a conventionally applied weld instrument dedicated for performance of a fusion operation between the edge member 22 and the metallic component 20. Various types of the welding torch 50 may be contemplated, such as but not limited to, an electric arc weld torch, a plasma weld torch, and a laser weld torch. In an embodiment, both the metallic component 20 and the edge member 22 may be provided with chamfered edges so as to define a material receiving portion at the associated connection interface and the receive a filler material, during a weld operation.

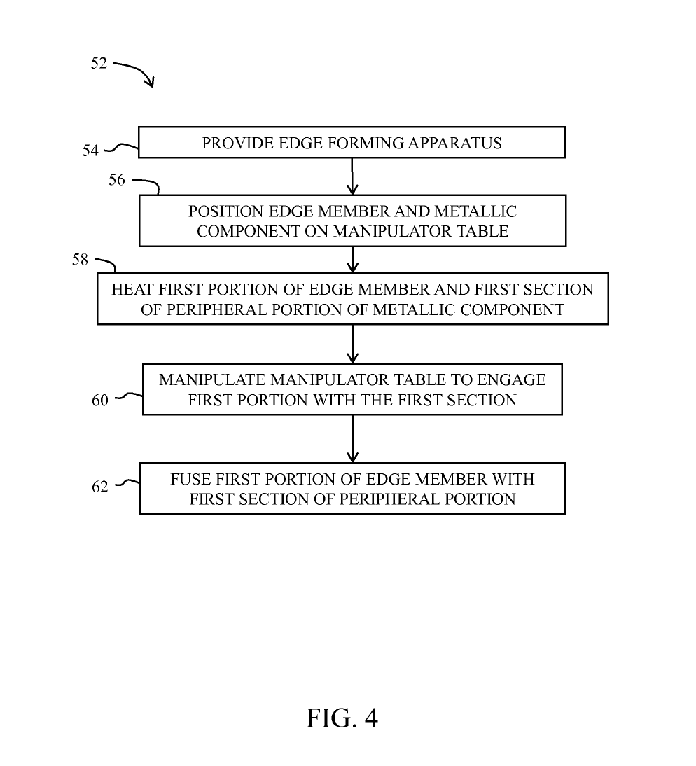

Referring to FIG. 4, there is shown a flowchart of a method 52 for fusing the edge member 22 to the peripheral portion 24 the metallic component 20. The method 52 initiates at step 54.

At step 54, the edge forming apparatus 30, 30′ is provided. The manipulator 32, the heating unit 36, the set of rollers 38, and the scarfing tool 40 are adjusted to initiate fusion between the metallic component 20 and the edge member 22. Additionally, the control unit 34 is provided with an input of the profile of the metallic component 20. The method 52 then proceeds to step 56.

At step 56, both of the metallic component 20 and the edge member 22 are positioned on the manipulator 32 of the edge forming apparatus 30, 30′. The positioning of the metallic component 20 and the edge member 22 is such that the first portion 42 of the edge member 22 and the first section 44 of the metallic component 20 are positioned in the heating unit 36. Additionally, the metallic component 20 and the edge member 22 are positioned on the manipulator 32, such that the component attachment portion 26 of the edge member 22 faces the peripheral portion 24 of the metallic component 20. The method 52 then proceeds to step 58.

At step 58, the first portion 42 of the edge member 22 and the first section 44 of the metallic component 20 are heated, with use of the heating unit 36. More specifically, the heating unit 36 is energized, to heat the first portion 42 and the first section 44. The method 52 then proceeds to step 60.

At step 60, the manipulator 32 is manipulated to facilitate an engagement between the first portion 42 and the first section 44. More specifically, the manipulator 32 is rotated to pass the first portion 42 of the edge member 22 and the first section 44 of the metallic component 20 through the set of rollers 38. The method 52 then proceeds to step 62.

At step 62, the first portion 42 and the first section 44 are fused with each other, to facilitate attachment between the first portion 42 of the edge member 22 and the first section 44 of the metallic component 20. More specifically, the component attachment portion 26 at the first portion 42 of the edge member 22 fuses with the first section 44 of the peripheral portion 24 of the metallic component 20. This facilitates a joint between the edge member 22 and the metallic component 20.

### INDUSTRIAL APPLICABILITY

In operation, the first side plate 14 of the boom 10 is manufactured by welding the edge member 22 to the peripheral portion 24 of the metallic component 20. The edge forming apparatus 30 is employed to facilitate fusion between the edge member 22 and the metallic component 20. To initiate the process of fusion, an operator initially sets the edge forming apparatus 30. More specifically, the operator inputs the control unit 34 with a profile of the peripheral portion 24 of the metallic component 20.

After setting the edge forming apparatus 30, the metallic component 20 and the edge member 22 are positioned on the manipulator 32 of the edge forming apparatus 30. Positioning of the metallic component 20 and the edge member 22 is such that the first portion 42 of the edge member 22 and the first section 44 of the metallic component 20 are positioned in the heating unit 36 of the edge forming apparatus 30. Moreover, the metallic component 20 and the edge member 22 are so positioned that the component attachment portion 26 of the edge member 22 faces the peripheral portion 24 of the metallic component 20. Once the metallic component 20 and the edge member 22 are positioned on the manipulator 32, the operator energizes the heating unit 36 of the edge forming apparatus 30. The heating unit 36 heats the first portion 42 and the first section 44. This facilitates the edge member 22 to be able to be bent and positioned, conforming to a variable profile of the peripheral portion 24 of the metallic component 20. Thereafter, the operator actuates the control unit 34, to initiate manipulation of the manipulator 32. More specifically, the control unit 34 rotates the manipulator 32 to pass the first portion 42 and the first section 44 through the set of rollers 38. While passing through the rollers 38, the edge member 22 is bent and an engagement between the first portion 42 and the first section 44, is facilitated. More specifically, an engagement between the component attachment portion 26 of the first portion 42 and the first section 44 of the peripheral portion 24 of the metallic component 20, is facilitated. As the first portion 42 and the first section 44 are pre-heated portions of the edge member 22 and the metallic component 20, the first portion 42 is fused with the first section 44. This facilitates solid-state fusion between the edge member 22 and the metallic component 20. In the alternate embodiment of the edge forming apparatus 30′, the welding torch 50 is employed to facilitate liquid-state fusion of the edge member 22 with the peripheral portion 24 of the metallic component 20.

The manipulator 32 is further manipulated to pass other portions of the edge member 22 and the metallic component 20 through each of the heating unit 36 and the set of rollers 38. This facilitates fusion of the edge member 22 to the peripheral portion 24 of the metallic component 20. More specifically, this method 52 facilitates fusion of the component attachment portion 26 of the edge member 22 to the peripheral portion 24 of the metallic component 20. As the thickened portion 28 of the edge member 22 is relatively thicker than the component attachment portion 26 and, in turn, the metallic component 20, a thicker edge of the first side plate 14 is obtained. Therefore, the first side plate 14 is manufactured with a substantially thickened edge, with relative ease in manufacturing, and without substantially affecting statutory dimensional requirements of the metallic component 20. Further, such a method 52 avoids pre-calculations required to obtain a generally thickened periphery of the first side plate 14. This is beneficial since pre-calculations required taking into consideration the degree of heat imparted, the material used, material thickness, and the like, which increases effort and undue utilization of resources in conventional manufacturing practices.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method of fusing an edge member to a peripheral portion of a metallic component, the method comprising:
providing an edge forming apparatus with a manipulator capable of receiving the edge member and the metallic component, the edge forming apparatus including a heating unit and at least one set of rollers;
positioning the edge member and the metallic component on the manipulator;
heating a first portion of the edge member and a first section of the peripheral portion with use of the heating unit;
manipulating the manipulator to facilitate an engagement between the first portion of the edge member and the first section of the peripheral portion by passing the first portion and the first section through the at least one set of rollers; and
fusing the first portion of the edge member with the first section of the peripheral portion of the metallic component.
